(19) United States
(12) Patent Application Publication
(10) Pub. No.: US 2026/0184089 A1
(43) Pub. Date: Jul. 2, 2026

(54) PRINTING APPARATUS AND PRINTING SYSTEM

(71) Applicant: SCREEN Holdings Co., Ltd., Kyoto (JP)

(72) Inventor: Kazuma TANI, Kyoto-shi (JP)

(21) Appl. No.: 19/417,470

(22) Filed: Dec. 12, 2025

(30) Foreign Application Priority Data
Dec. 27, 2024 (JP) 2024-231642

(51) Int. Cl. B41J 11/42; B41J 11/00; B41J 15/04; G06F 3/12

(52) U.S. Cl. CPC B41J 11/42; B41J 11/00214; B41J 11/0095; B41J 15/048; G06F 3/1219; G06F 3/1229; G06F 3/1285

(57) ABSTRACT

A printing apparatus comprises: a transport mechanism that transports a base material; a printing unit that records a print image on the base material, and a control unit that controls each unit in the printing apparatus. The control unit includes a printing controller and a calculation processor. The printing controller controls the transport mechanism and the printing unit, and switches between a first mode and a second mode differing from each other in a configuration of printing on the base material by the printing unit and implements the switched mode. The calculation processor estimates or actually measures a first non-printed amount and a second non-printed amount relating to one job. The first non-printed amount corresponds to the length of a non-printed region of the base material in the first mode. The second non-printed amount corresponds to the length of a non-printed region of the base material in the second mode. As a result, it is possible to grasp a saved amount of the base material in the second mode. Specifically, in the printing apparatus having a plurality of operation modes, a user is allowed to grasp a difference in a used amount or in a saved amount of the base material resulting from the operation modes.

### RELATED APPLICATIONS

This application claims the benefit of Japanese Application No. 2024-231642, filed on Dec. 27, 2024, the disclosure of which is incorporated by reference herein.

### BACKGROUND OF THE INVENTION

### Field of the Invention

The present invention relates to a printing apparatus and a printing system that record a print image on an elongated strip-shaped base material.

### Description of the Background Art

In a printing apparatus that performs printing on an elongated strip-shaped base material, an unprinted region may be caused in the base material in a conventional case. If the base material is driven while in a transport stopped state, for example, the base material is usually accelerated to a predetermined set transport speed and then printing is started. Hence, the base material having been transported until a transport speed of the base material reaches the set transport speed results in the unprinted region. If a printing state about a predetermined job is to be checked and then a next job is to be executed, a region of the base material having been subjected to printing based on the job to be checked is required to be transported to a check position much closer to a downstream side than a printing position. In this case, a region of the base material located along a transport path from the printing position to the check position cannot be subjected to printing, so that this region of the base material results in the unprinted region.

In order to reduce the occurrence of the unprinted region in the base material and reduce the occurrence of waste in the base material, a printing apparatus having a mode allowing saving of the base material has been developed conventionally. As an example, there is a known printing apparatus having the function of starting printing during acceleration of the base material from the transport stopped state to a stable transport speed of the base material. As another example, Japanese Patent Application Laid-Open No. 2020-163667 shows a printing apparatus that allows the unprinted region to be shortened by transporting the base material in a direction reverse to a transport direction.

As described above, if the mode allowing saving of the base material is prepared as an operation mode, an extension of the unprinted region is smaller in the base material saving mode than in a usual node. A configuration has not been devised conventionally for causing a user to grasp a difference in the extension of the unprinted region resulting from these different operation modes.

In the base material saving mode, however, reduction in the extension of the unprinted region generally causes a region where printing quality is reduced. Specifically, there is a trade-off between the amount of the base material to be saved and printing quality. For this reason, it is a great advantage for a user to grasp the length of the unprinted region to be saved by the base material saving mode or corresponding cost related to the base material.

### SUMMARY OF THE INVENTION

The present invention has been made in view of the foregoing circumstances. In a printing apparatus having a plurality of operation modes, the present invention is intended to provide a technique allowing a user to grasp a difference in a used amount or in a saved amount of a base material resulting from the operation modes.

In order to solve the above problem, a first aspect of the present invention is intended for a printing apparatus that performs printing on an elongated strip-shaped base material transported in a transport direction, comprising: a transport mechanism that transports said base material; a printing unit that records a print image by causing a recording agent to adhere to said base material; and a control unit that controls each unit in said printing apparatus. The control unit includes: a printing controller that controls said transport mechanism and said printing unit, and switches between a first mode and a second mode differing from each other in a configuration of printing on said base material by said printing unit and implements the switched mode; and a calculation processor that estimates or actually measures a first non-printed amount and a second non-printed amount relating to one job. The first non-printed amount corresponds to the length of a non-printed region of said base material in said first mode. The second non-printed amount corresponds to the length of a non-printed region of said base material in said second mode.

According to a second aspect of the present invention, the printing apparatus according to the first aspect further comprises: a display unit allowing information about the printing apparatus to be displayed thereon. The control unit further includes: a display controller that displays base material usage information on said display unit having been output from said calculation processor. The base material usage information includes at least either said first non-printed amount and said second non-printed amount, or a difference between said first non-printed amount and said second non-printed amount. The calculation processor estimates said first non-printed amount and said second non-printed amount before start of execution of said job. The display controller displays said base material usage information on said display unit.

According to a third aspect of the present invention, the printing apparatus according to the first aspect further comprises: a display unit allowing information about the printing apparatus to be displayed thereon. The control unit further includes: a display controller that displays base material usage information on said display unit having been output from said calculation processor. The base material usage information includes at least either said first non-printed amount and said second non-printed amount, or a difference between said first non-printed amount and said second non-printed amount. After execution of said job in said second mode is finished, said calculation processor estimates said first non-printed amount and calculates said second non-printed amount on the basis of result actually measured during implementation of printing. The display controller displays said base material usage information on said display unit after execution of said job is finished.

According to a fourth aspect of the present invention, in the printing apparatus according to the first to third aspects, in said first mode, when said printing controller starts execution of said job, said printing controller causes said transport mechanism to start transport of said base material and thereafter causes said printing unit to start printing after acceleration is completed and a predetermined stable transport speed is reached, in said second mode, when said printing controller starts execution of said job, said printing controller causes said transport mechanism to start transport of said base material and thereafter causes said printing unit to start printing while acceleration proceeds and before said stable transport speed is reached, said first non-printed amount is calculated on the basis of a transported amount of said base material in said first mode by which said base material is transported from a transport start position of said base material to arrive at a printing start position after a transport speed of said base material reaches said stable transport speed, and said second non-printed amount is calculated on the basis of a transported amount of said base material in said second mode by which said base material is transported from a transport start position of said base material to arrive at a printing start position while acceleration of said base material proceeds.

According to a fifth aspect of the present invention, in the printing apparatus 20 according to the fourth aspect, an acceleration of said base material at the start of execution of said job in said second mode is lower than an acceleration of said base material at the start of execution of said job in said first mode.

According to a sixth aspect of the present invention, in the printing apparatus according to the first to third aspects, in said first mode, when said printing controller starts execution of said job, said printing controller causes said transport mechanism to start transport of said base material without changing the position of said base material and thereafter causes said printing unit to start printing, in said second mode, before said printing controller starts execution of said job, said printing controller causes said transport mechanism to perform reverse transport of transporting said base material in a reverse direction, thereafter causes said transport mechanism to start transport of said base material in a forward direction, and then causes said printing unit to start printing, said first non-printed amount is calculated on the basis of a transported amount of said base material in said first mode by which said base material is transported from a transport start position of said base material to arrive at a printing start position of said base material, and said second non-printed amount is calculated on the basis of an amount in said second mode obtained by subtracting a transported amount of said base material by which said base material is transported during said reverse transport from a transported amount of said base material by which said base material is transported from a transport start position of said base material to arrive at a printing start position of said base material after said reverse transport.

A seventh aspect of the present invention is intended for printing system comprising: one or a plurality of printing apparatuses that performs printing on an elongated strip-shaped base material transported in a transport direction; and a server computer including a server display unit and communicable with said printing apparatus via a network. Each of said printing apparatuses includes: a transport mechanism that transports said base material; a printing unit that records a print image by causing a recording agent to adhere to said base material; and a control unit that controls each unit in said printing apparatus. The control unit includes: a printing controller that controls said transport mechanism and said printing unit, and switches between a first mode and a second mode differing from each other in a configuration of printing on said base material by said printing unit and implements the switched mode; a calculation processor that estimates a first non-printed amount and calculates a second non-printed amount relating to a job having been completed in said second mode, the first non-printed amount corresponding to the length of a non-printed region of said base material in said first mode, the second non-printed amount corresponding to the length of a non-printed region of said base material in said second mode and calculated on the basis of result actually measured during implementation of printing; and a communication part that transmits base material usage information having been output from said calculation processor to said server computer. The base material usage information includes at least either said first non-printed amount and said second non-printed amount, or a difference between said first non-printed amount and said second non-printed amount. The server computer includes: a server communication part that receives said base material usage information from said printing apparatus via said network; and a server storage part storing said base material usage information received by said server communication part. The server communication part is capable of transmitting said base material usage information stored in the server storage part to an external user computer via said network.

According to the first to seventh aspects of the present invention, in a printing apparatus having a plurality of operation modes, a user is allowed to grasp a difference in a used amount or in a saved amount of a base material resulting from the operation modes.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 conceptually shows the configuration of a printing system according to one preferred embodiment;

FIG. 2 is a block diagram showing the configuration of a printing apparatus according to one preferred embodiment;

FIG. 3 is a perspective view showing the configuration of a meandering compensating unit according to one preferred embodiment;

FIG. 4 is a block diagram showing a control system of the printing system according to one preferred embodiment;

FIG. 5 shows time series changes in a transport speed of a base material in a standard mode and a printing mode during acceleration of the printing apparatus according to one preferred embodiment;

FIG. 6 shows positions before start of execution of a new job in the printing apparatus according to one preferred embodiment;

FIG. 7 shows setting of a non-printed region in a reverse transport mode in the printing apparatus according to one preferred embodiment;

FIG. 8 shows an exemplary display format on a user computer in the printing system according to one preferred embodiment; and

FIG. 9 shows a time series change in a transport speed of a base material in a standard mode and a printing mode during acceleration of a printing apparatus according to a modification.

### DESCRIPTION OF THE PREFERRED EMBODIMENTS

A preferred embodiment of the present invention will be described below by referring to the drawings. In the following, a direction in which a base material 9 is transported will be called a “transport direction,” and a horizontal direction perpendicular to the transport direction will be called a “width direction.” An upstream side of the transport direction will simply be called an “upstream side,” and a downstream side of the transport direction will simply be called a “downstream side.”

### <1. Configuration of Printing System>

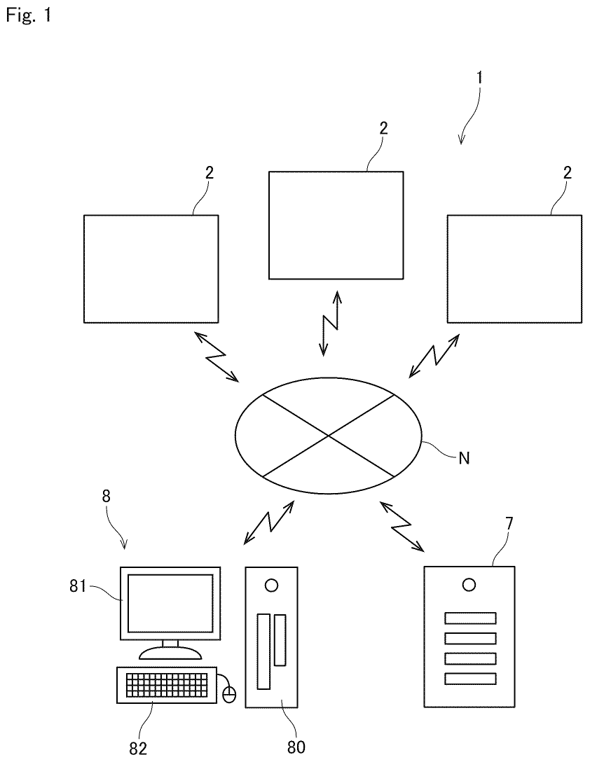

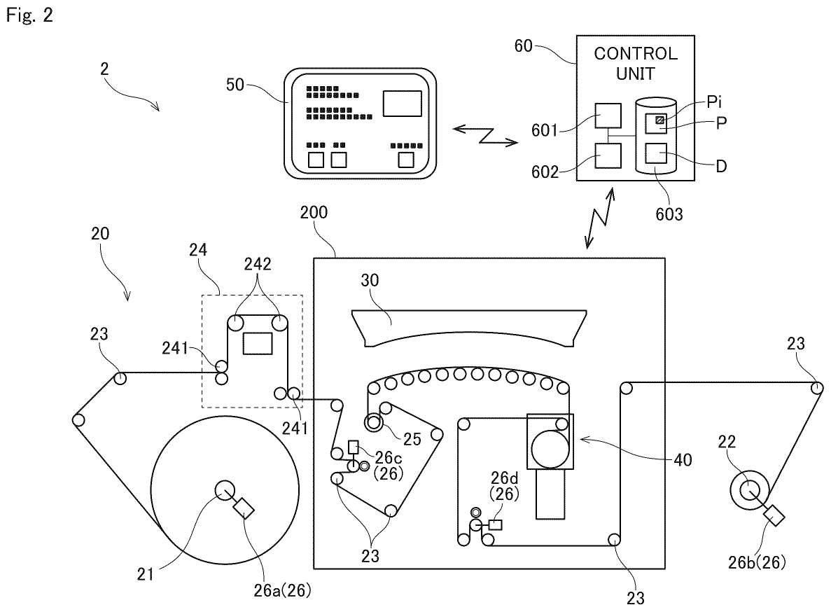

FIG. 1 conceptually shows the configuration of a printing system 1 according to one preferred embodiment of the present invention. FIG. 2 conceptually shows the configuration of a printing apparatus 2 belonging to the printing system 1. The printing system 1 is a system for managing one or a plurality of printing apparatuses 2. The printing apparatus 2 is an apparatus that performs a printing process on the elongated strip-shaped base material 9 while transporting the base material 9.

The printing system 1 includes one, or the plurality of printing apparatuses 2, a server computer 7, and a user computer 8. The plurality of printing apparatuses 2, the server computer 7, and the user computer 8 are connected to each other via a network N such as the Internet. As shown in FIG. 1, the printing system 1 of this preferred embodiment includes three printing apparatuses 2.

The printing apparatus 2 and the user computer 8 belong to a user. On the other hand, in the this preferred embodiment, the server computer 7 belongs to a business operator to offer service to a plurality of users. The server computer 7 manages information about the printing apparatus 2 belonging to a user. The user is allowed to browse information via the user computer 8 about the printing apparatus 2 belonging to the user himself or herself and managed by the server computer 7. The server computer 7 may be connected via a network to the printing apparatus 2 belonging to each of a plurality of users and to the user computer 8, and may be configured to manage information about the printing apparatus 2 belonging to each of the users.

As shown in FIG. 2, the printing apparatus 2 includes a transport mechanism 20, a printing unit 30, a UV irradiator 40, an operation unit 50, and a control unit 60. A printing controller 61 of the control unit 60 described later controls operations of the transport mechanism 20, the printing unit 30, and the UV irradiator 40.

The transport mechanism 20 includes an unwinding part 21, a winding part 22, a plurality of transport rollers 23, and a plurality of motors 26. The unwinding part 21, the winding part 22, and the transport rollers 23 are each rotatable about a horizontal axis.

The motor 26 as a power source is coupled to each of the unwinding part 21, the winding part 22, and some of the transport rollers 23. More specifically, the plurality of motors 26 includes an unwinding motor 26a coupled to the unwinding part 21, a winding motor 26b coupled to the winding part 22, and transport motors 26c and 26d coupled to corresponding two of the transport rollers 23. Specifically, some of the transport rollers 23 are drive rollers coupled to the transport motors 26c and 26d, and the other transport rollers 23 are driven rollers to rotate in response to the motion of the base material 9 without being coupled to motors. However, all the transport rollers 23 may be driven rollers.

The transport rollers 23 form a transport path of the base material 9 between the unwinding part 21 and the winding part 22. Each of the transport rollers 23 rotates about the horizontal axis to guide the base material 9 toward the downstream side of the transport path. Specifically, after being unwound from the unwinding part 21, the base material 9 is passed along the transport path defined by the transport rollers 23 and others and then collected on the winding part 22.

When the printing controller 61 drives each of the motors 26 in a forward direction, each of the unwinding part 21, the winding part 22, and the transport rollers 23 rotates in the forward direction. By doing so, the base material 9 held in a roll shape on the unwinding part 21 is unwound from the unwinding part 21, transported in the forward direction along the transport path, and then wound in a roll shape around the winding part 22.

When the printing controller 61 drives each of the motors 26 in a reverse direction, each of the unwinding part 21, the winding part 22, and the transport rollers 23 rotates in the reverse direction. In this case, the base material 9 wound around the winding part 22 is unwound, transported in the reverse direction along the transport path, and then wound in a roll shape around the unwinding part 21.

The transport mechanism 20 includes a meandering compensating unit 24 and an encoder 25 provided on the transport path.

The meandering compensating unit 24 is a mechanism for compensating for the position of the base material 9 in the width direction. In this preferred embodiment, the meandering compensating unit 24 is located on the upstream side of the transport path with respect to the printing unit 30.

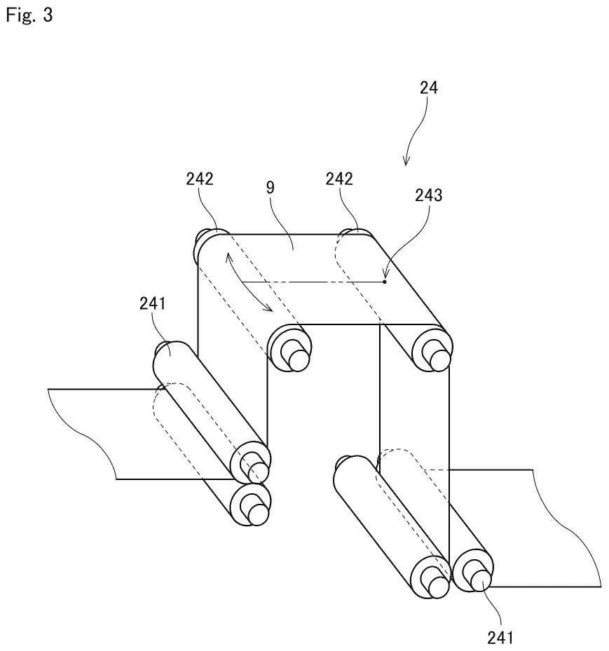

FIG. 3 is a perspective view showing the configuration of the meandering compensating unit 24. As shown in FIG. 3, the meandering compensating unit 24 of this preferred embodiment includes a pair of fixed rollers 241 and a pair of guide rollers 242. Both the pair of fixed rollers 241 and the pair of guide rollers 242 rotate in a state of contacting the base material 9, thereby guiding the base material 9 toward the downstream side. A moving mechanism not shown in the drawings is connected to the pair of guide rollers 242. By operating the moving mechanism, the pair of guide rollers 242 makes turning motion about a point called a pivot 243 to swing in the width direction. This allows the base material 9 to be displaced in the width direction.

However, the meandering compensating unit 24 of the present invention is not limited to the above configuration. The meandering compensating unit 24 may be configured to displace the base material 9 in the width direction by tilting the guide rollers 242, for example.

The encoder 25 is a mechanism for measuring a transported amount of the base material 9. In this preferred embodiment, the encoder 25 is located on the upstream side of the transport path with respect to the printing unit 30.

In performing the printing process in the printing apparatus 2, the base material 9 is unwound from the unwinding part 21, subjected to processes sequentially at the printing unit 30 and the UV irradiator 40, and then collected on the winding part 22.

The printing unit 30 records an image on an upper surface of the base material 9. The printing unit 30 ejects ink droplets to the base material 9 transported by the transport mechanism 20. In this way, the printing unit 30 causes ink as a recording agent to adhere to the base material 9, thereby recording a print image. The printing unit 30 includes at least one recording head. In this preferred embodiment, the printing unit 30 includes four recording heads that sequentially eject ink droplets of cyan (C), magenta (M), yellow (Y), and black (K) onto the upper surface of the base material 9. In this preferred embodiment, the ink used by the printing unit 30 is ultraviolet-curable ink to be cured by ultraviolet irradiation.

The printing apparatus 2 of this preferred embodiment is a so-called one-pass type inkjet printer that records an intended print image on the base material 9 by ejecting ink droplets from the recording heads each having a recording width equal to or greater than the sheet width of the base material 9 while the base material 9 passes under each of the recording heads only once.

The UV irradiator 40 applies ultraviolet light to a surface of the base material 9. By doing so, ink droplets ejected to the surface of the base material 9 by the printing unit 30 is cured and fixed on the base material 9.

The operation unit 50 is a unit capable of inputting information such as an operation command to the control unit 60 and displaying information transmitted from the control unit 60. Specifically, the operation unit 50 functions as an input unit to input information to the control unit 60 and as a display unit to present information from the control unit 60 to a user. A touch panel is used as the operation unit 50, for example. The operation unit 50 may be separated into an input unit such as a keyboard and a mouse, and a display unit such as a liquid crystal display. The operation unit 50 may include an input unit or a display unit in addition to a touch panel.

The control unit 60 is control means for controlling the operation of each unit in the printing apparatus 2. As conceptually shown in FIG. 2, the control unit 60 of this preferred embodiment is configured using a computer including an arithmetic processor 601 such as a CPU, a memory 602 such as a RAM, and a storage part 603 such as a hard disk drive.

The control unit 60 of this preferred embodiment is configured by installing the computer with an operation control program Pi about the printing apparatus 2. The storage part 603 of the control unit 60 stores a computer program P including the operation control program Pi, and data D.

The control unit 60 reads the computer program P and the data D from the storage part 603 temporarily onto the memory 602, and causes the arithmetic processor 601 to perform arithmetic processing on the basis of the read computer program P and data D, thereby controlling the operation of each unit in the printing apparatus 2. This causes the transport mechanism 20 to proceed further with the process of transporting the base material 9 and causes the printing unit 30 to proceed further with the printing process.

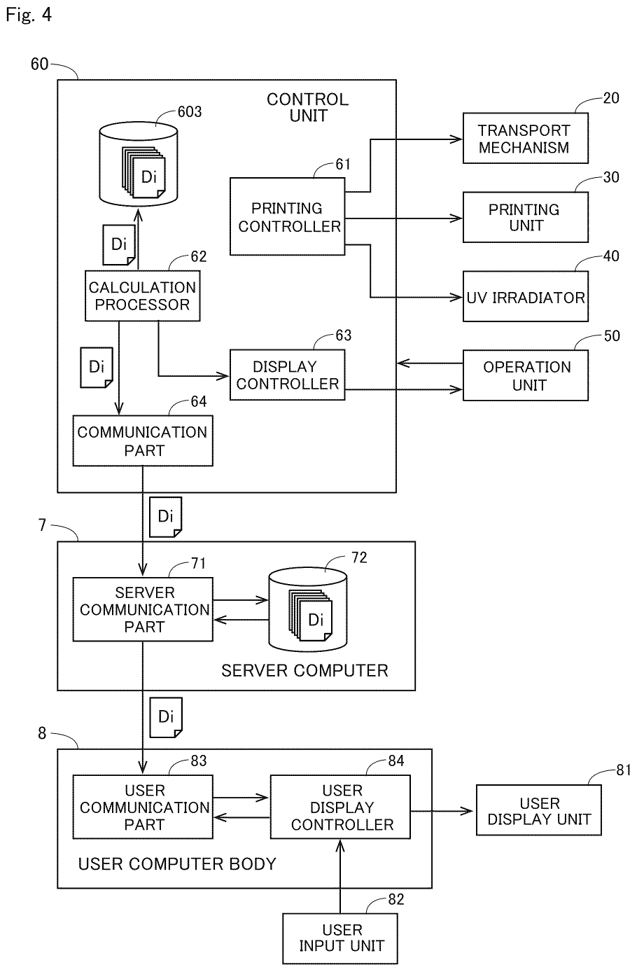

FIG. 4 is a control block diagram relating to the printing system 1. As shown in FIG. 4, the control unit 60 has processors realized in the form of software including the printing controller 61, a calculation processor 62, a display controller 63, and a communication part 64.

The printing controller 61 controls the transport mechanism 20, the printing unit 30, and the UV irradiator 40. The printing controller 61 controls the transport process by the transport mechanism 20, the printing process by the printing unit 30, and the process of curing ink by the UV irradiator 40.

The printing controller 61 switches between a first mode and a second mode and implements the switched mode as a printing mode. The first mode and the second mode differ from each other in a configuration of printing on the base material by the printing unit 30 after the transport mechanism 20 starts transport of the base material 9. More specifically, the first mode and the second mode differ from each other in a printing start position where the printing unit 30 starts printing on the base material 9. In this preferred embodiment, the first mode is a conventional standard mode and the second mode is an eco-friendly mode in which a non-printed region of the base material 9 is reduced compared to the first mode. The non-printed region means a region on the base material 9 not to be subjected to printing by the printing unit 30, and is usually a region interposed between a printed region where printing is performed on the basis of a preceding job and a printed region where printing is performed on the basis of a subsequent job.

The calculation processor 62 calculates a first non-printed amount D1 and a second non-printed amount D2 relating to one print job by estimation or by actual measurement. The first non-printed amount D1 is the length of a non-printed region of the base material 9 in the first mode. The second non-printed amount D2 is the length of a non-printed region of the base material 9 in the second mode. The calculation processor 62 calculates a base material saved amount ΔD showing a difference between the first non-printed amount D1 and the second non-printed amount D2.

The display controller 63 displays “base material usage information Di” on the operation unit 50 having been output from the calculation processor 62. The base material usage information Di includes the first non-printed amount D1 and the second non-printed amount D2, or the base material saved amount AD, or includes both the first non-printed amount D1 and the second non-printed amount D2, and the base material saved amount AD. Namely, the base material usage information Di includes at least either the first non-printed amount D1 and the second non-printed amount D2, or the base material saved amount AD.

The communication part 64 transmits the base material usage information Di having been output from the calculation processor 62 to the server computer 7 via the network N.

The server computer 7 is a computer for managing information about the plurality of printing apparatuses 2. The server computer 7 of this preferred embodiment is managed by an administrator of the printing system 1, not by users of these printing apparatuses 2. However, all the printing apparatuses 2, the server computer 7, and the user computer 8 may be managed by a user.

The server computer 7 includes a server communication part 71 and a server storage part 72. The server communication part 71 receives the base material usage information Di from the printing apparatus 2 via the network N. The server communication part 71 is capable of transmitting the base material usage information Di in the server storage part 72 to the external user computer 8 via the network N. The server storage part 72 stores the base material usage information Di received by the server communication part 71.

In addition to the base material usage information Di, the server computer 7 receives various types of information about the printing process transmitted from the printing apparatus 2. The transmitted information corresponds to each printing apparatus 2, and contains information about each job such as date and time of implementation of the printing process, a type of the base material 9, respective consumed amounts of the base material 9 and the ink, cost or a CO₂ emission resulting from the consumption of the base material 9 and the ink, and others.

The user computer 8 is to be used by a user. A general personal computer may be used as the user computer 8. A user of the printing apparatus 2 is allowed to browse information via the user computer 8 about the printing process by the printing apparatus 2 saved in the server computer 7.

As shown in FIG. 1, the user computer 8 includes a user computer body 80, a user display unit 81 such as a display, and a user input unit 82 including a keyboard and a mouse, for example. The user computer body 80 has processors realized in the form of software including a user communication part 83 and a user display controller 84. In response to a command input from the user input unit 82, the user communication part 83 receives information from the server computer 7 via the network N. The received information is about the printing process by the printing apparatus 2 to be used by a user using the user computer 8, and includes the base material usage information Di and others. Then, in response to a command input from the user input unit 82, the user display controller 84 displays the received information including the base material usage information Di on the user display unit 81.

In the described printing system 1, before start of execution of a new job, a user is capable of causing the calculation processor 62 to estimate the first non-printed amount D1 in the first mode and the second non-printed amount D2 in the second mode relating to the new job. More specifically, before start of execution of the new job, the calculation processor 62 estimates the first non-printed amount D1 and the second non-printed amount D2 by an estimation method described later. At this time, the calculation processor 62 may calculate the base material saved amount AD. Then, the display controller 63 causes the operation unit 50 to display the base material usage information Di. Specifically, the display controller 63 causes the operation unit 50 to display the first non-printed amount D1 and the second non-printed amount D2, and/or the base material saved amount AD. This allows the user to check a difference in the non-printed amount between the modes when the user selects a mode before start of execution of the new job at the operation unit 50.

Regarding a printed job having been subjected to the printing process in the second mode, the calculation processor 62 estimates the first non-printed amount D1 in the first mode relating to the printed job, and on the basis of result about the printed job actually measured during the printing process, calculates the second non-printed amount D2 in the second mode relating to the printed job. In doing this, the calculation processor 62 calculates the second non-printed amount D2 on the basis of a transported amount of the base material 9 measured by the encoder 25. At this time, the calculation processor 62 may calculate the base material saved amount AD.

After printing of the printed job is finished, the display controller 63 causes the operation unit 50 to display the base material usage information Di. This allows a user to check an actual saved amount of the base material 9 after the printing process.

The user is allowed to acquire various types of information using the user computer 8 from the server computer 7 via the network N. The acquired information is about the printed job having been subjected to the printing process in the second mode, and includes the base material usage information Di and others.

### <2. Method of Estimating Non-Printed Amount in Each Mode>

Described next is a method of calculating a non-printed amount in each mode relating to each job in the printing apparatus 2. In this preferred embodiment, the first mode is a conventional standard mode and the second mode is an eco-friendly mode in which a non-printed region of the base material 9 is reduced compared to the first mode. In this preferred embodiment, the second mode has two types of modes including a printing mode during acceleration and a reverse transport mode.

### <2-1. Non-Printed Amount in Standard Mode (First Mode)>

Described first is a method of calculating the first non-printed amount corresponding to the length of a non-printed region in the standard mode as the first mode. In the following, a job as a next printing target will be called a new job and the job previous to the new job will be called a previous job.

In the standard mode, if the base material 9 is in a stopped state before execution of the new job is started, the printing controller 61 starts execution of the new job and at the same time, causes the transport mechanism 20 to start transport of the base material 9. Then, after acceleration of the base material 9 is completed to reach a predetermined stable transport speed, the printing controller 61 causes the printing unit 30 to start printing.

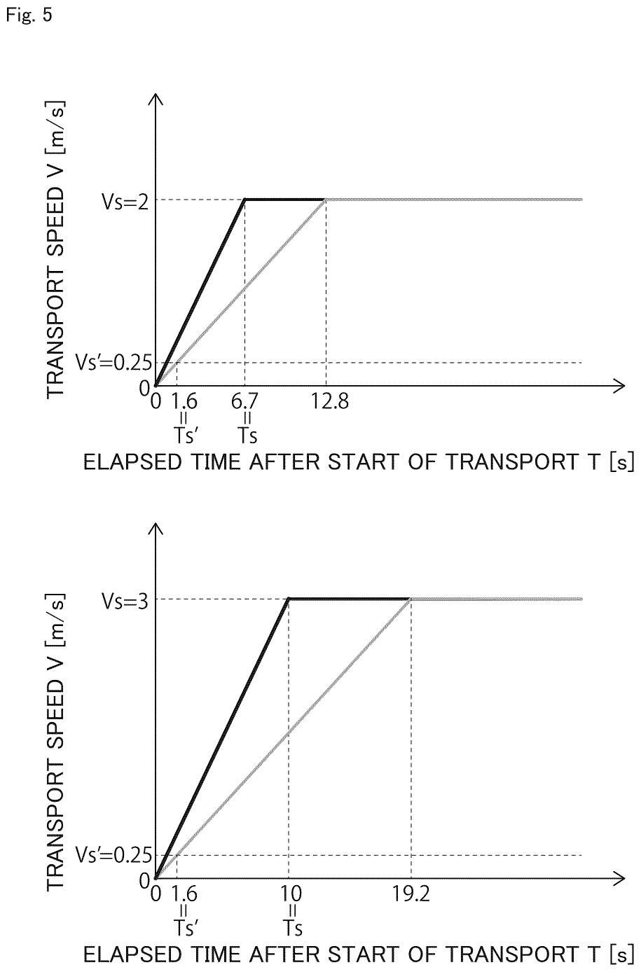

FIG. 5 shows time series changes in a transport speed V [m/s] of the base material 9 in the standard mode and the printing mode during acceleration. In FIG. 5, a horizontal axis shows an elapsed time T [s] after start of transport, and a vertical axis shows a transport speed [m/s]. The upper section in FIG. 5 shows a case where the stable transport speed is 2 [m/s], and the lower section in FIG. 5 shows a case where the stable transport speed is 3 [m/s]. In FIG. 5, the standard mode is shown in black, and the printing mode during acceleration is shown in gray.

As shown in FIG. 5, in the standard mode of this preferred embodiment, transport of the base material 9 by the transport mechanism 20 is started before start of printing and the transport speed V is increased with a constant acceleration. In the example in FIG. 5, the transport speed V is increased with an acceleration of 0.3 [m/s²]. When the transport speed V reaches a stable transport speed Vs, the printing process by the printing unit 30 is started.

Then, with the stable transport speed defined as Vs [m/s] and the elapsed time after start of transport (hereinafter called a “printing start time”) defined as Ts [s] in the standard mode, a length Ls1 of the base material 9 transported in a period from start of transport of the base material 9 to start of printing is expressed by the following formula.

$$\begin{matrix}[ Formula 1 ] & \\ Ls 1 = \frac{1}{2} * Vs * Ts & ( 1 )\end{matrix}$$

Thus, as shown in the upper section in FIG. 5, if the stable transport speed Vs is 2 [m/s] and the printing start time Ts is 6.7 [s], Ls1 is calculated as 6.7 [m]. As shown in the lower section in FIG. 5, if the stable transport speed Vs is 3 [m/s] and the printing start time is 10 [s], Ls1 is calculated as 15 [m].

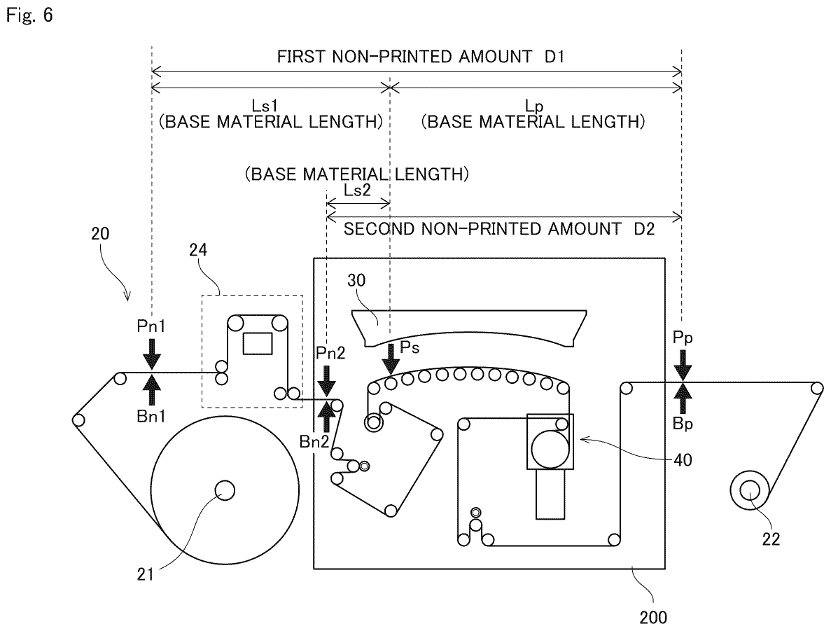

FIG. 6 shows positions Bp, Bn1 and Bn2 on the base material 9 and positions Pp, Pn1, Pn2 and Ps along the transport path at a time before start of execution of the new job. More specifically, a rear end position of a printed region on the base material 9 based on the previous job is defined as the position Bp, a rear end position of the printed region along the transport path based on the previous job is defined as the position Pp, a printing start position along the transport path where the printing unit 30 starts printing is defined as the position Ps, a printing start position on the base material 9 where printing based on the new job is started in the standard mode is defined as the position Bn1, a printing start position on the base material 9 where printing based on the new job is started in the printing mode during acceleration is defined as the position Bn2, and positions along the transport path where the positions Bn1 and Bn2 on the base material 9 are located before start of execution of the new job are defined as the positions Pn1 and Pn2 respectively.

For reference, FIG. 6 shows ranges of the base material lengths Ls1, Ls2 and Lp, and those of regions to become the first non-printed amount D1 and the second non-printed amount D2 in the standard mode and the printing mode during acceleration. These lengths indicated by double-pointed arrows do not show the lengths of the base material 9 included in the corresponding regions. Reason for this is that, with the presence of bends at the transport path of the base material 9, the positions Pn1 and Pn2 are defined at locations simple to understand.

After execution of the previous job and before start of execution of the new job, the rear end position Bp of the printed region on the base material 9 based on the previous job is usually located on the downstream side with respect to the printing unit 30 and the UV irradiator 40. At this time, a position along the transport path corresponding to the location of the position Bp on the base material 9 is Pp. In the example in FIG. 6, the rear end position Bp of the printed region on the base material 9 based on the previous job and the rear end position Pp along the transport path are located external to a housing 200 in order to allow a user to visually recognize the previous job including the rear end thereof.

The printing start position Ps where the printing unit 30 starts printing corresponds to a position where a print is to be made by an upstream-side end portion of a head among the plurality of heads of the printing unit 30 and located on the most upstream side.

The printing start positions Bn1 and Bn2 on the base material 9 based on the new job are located at the positions Pn1 and Pn2 respectively that are on the upstream side with respect to the printing start position Ps. In the standard mode, in a period from when the base material 9 in a stopped state reaches the stable transport speed Vs to when the printing unit 30 starts printing, the base material 9 is transported by the length Ls1. The position Pn1 along the transport path is a position separated by the length Ls1 toward the upstream side from the printing start position Ps. A position on the base material 9 located at the position Pn1 before start of printing based on the new job is defined as the position Bn1.

When the printing controller 61 starts execution of the new job, the transport mechanism 20 starts transport of the base material 9. By doing so, the position Bn1 on the base material 9 is transported toward the downstream side. When the position Bn1 moves farther by the length Ls1 to arrive at the printing start position Ps along the transport path, the base material 9 reaches the stable transport speed Vs and the printing unit 30 starts the printing process. In this way, with the position Bn1 on the base material 9 set as a printing start position, the printing unit 30 performs the printing process based on the new job on the base material 9.

Thus, when transport of the base material 9 is started from the state shown in FIG. 6, the base material 9 located from the position Pp to the position Pn at this moment results in a non-printed region. Specifically, a region on the base material 9 from the position Bp to the position Bn1 results in a non-printed region. At this time, the first non-printed amount D1 corresponding to the length of the non-printed region in the first mode is determined by adding the length Ls of the base material 9 from the position Pn to the position Ps and the length Lp of the base material 9 from the position Ps to the position Pp.

$$\begin{matrix}[ Formula 2 ] & \\ D 1 = Ls 1 + Lp & ( 2 )\end{matrix}$$

As described above, the first non-printed amount D1 is calculated on the basis of the transported amount Ls1 of the base material 9 in the standard mode as the first mode by which the base material 9 is transported from the transport start position of the base material 9 to arrive at the printing start position after a transport speed of the base material 9 reaches the stable transport speed.

<2-2. Non-Printed Amount in Printing Mode during Acceleration (Second Mode)>

Described next is a method of calculating the second non-printed amount corresponding to the length of a non-printed region in the printing mode during acceleration as one example of the second mode.

In the printing mode during acceleration, if the base material 9 is in a stopped state before execution of the new job is started, the printing controller 61 causes the transport mechanism 20 to start transport of the base material 9 and thereafter causes the printing unit 30 to start printing while acceleration proceeds and before the stable transport speed is reached.

As shown in FIG. 5, in the printing mode during acceleration of this preferred embodiment, transport of the base material 9 by the transport mechanism 20 is started before start of printing and the transport speed V is increased with a constant acceleration. In the example in FIG. 5, the acceleration of the base material 9 at the start of printing of the new job in the printing mode during acceleration is lower than the acceleration of the base material 9 in the standard mode. More specifically, while the transport speed V is increased with an acceleration of 0.3 [m/s²] in the standard mode, the transport speed V is increased with an acceleration of about 0.16 [m/s²] in the printing mode during acceleration.

The printing unit 30 may be timed to start printing when the transport speed of the base material 9 reaches a predetermined speed lower than the stable transport speed, or when a predetermined period of time has elapsed since start of transport of the base material 9. In the example in FIG. 5, printing based on the new job is started when the transport speed V of the base material 9 reaches 0.25 [m/s], specifically, when the elapsed time T after start of transport becomes 1.6 [s].

In the printing mode during acceleration, for some time after transport of the base material 9 is started, the printing unit 30 performs printing while the transport speed V of the base material 9 is accelerated. Thus, during the acceleration, it becomes necessary to change timing of ink ejection from ejection timing in the printing process performed at the stable transport speed Vs. In response to this, the acceleration of the base material 9 is made lower than that in the standard mode to facilitate adjustment of the ejection timing. As a result, it becomes possible to suppress printing quality reduction in an area where the printing process is performed during the acceleration. When the transport speed V reaches the stable transport speed Vs, the printing unit 30 can perform the printing process using ejection timing similar to that in the standard mode.

In the printing mode during acceleration, with a printing start speed defined as Vs' [m/s] and the printing start time defined as Ts' [s], the length Ls2 of the base material 9 transported in a period from start of transport of the base material 9 to start of printing is expressed by the following formula.

$$\begin{matrix}[ Formula 3 ] & \\ Ls 2 = \frac{1}{2} * {Vs}^{′} * {Ts}^{′} & ( 3 )\end{matrix}$$

Thus, as shown in the upper section and the lower section in FIG. 5, if the printing start speed Vs' is 0.25 [m/s] and the printing start time Ts' is 1.6 [s], Ls2 is calculated as 0.2 [m].

The length Ls2 of the base material 9 in the printing mode during acceleration by which the base material 9 is transported in a period from start of transport of the base material 9 to start of printing is smaller than the length Ls1 of the base material 9 in the standard mode by which the base material 9 is transported in a period from start of transport of the base material 9 to start of printing. Thus, as shown in FIG. 6, the printing start position Bn2 on the base material 9 where printing of the new job is started in the printing mode during acceleration is located on the downstream side with respect to the printing start position Bn1 on the base material 9 where printing of the new job is started in the standard mode. Specifically, the position Pn2 along the transport path is located on the downstream side with respect to the position Pn1. As described above, the printing unit 30 starts printing on the base material 9 at a position that is the position Bn1 in the standard mode and the position Bn2 in the printing mode during acceleration. The positions Bn1 and Bn2 are different positions. This makes a difference in the configuration of printing on the base material 9 by the printing unit 30 between the standard mode and the printing mode during acceleration, and the printing controller 61 is capable of switching between these modes.

When the transport mechanism 20 starts transport, the position Bn2 on the base material 9 is transported toward the downstream side. When the position Bn2 moves farther by the length Ls2 to arrive at the printing start position Ps along the transport path, the base material 9 reaches the printing start speed Vs' and the printing unit 30 starts the printing process. In this way, with the position Bn2 on the base material 9 set as a printing start position, the printing unit 30 performs the printing process based on the new job on the base material 9.

When transport of the base material 9 is started from the state shown in FIG. 6, a region on the base material 9 located from the position Pp to the position Pn2 at the moment of start of transport of the base material 9 results in a non-printed region. Specifically, a region on the base material 9 from the position Bp to the position Bn2 results in a non-printed region. At this time, the second non-printed amount D2 corresponding to the length of the non-printed region in the second mode is determined by adding the length Ls2 of the base material 9 from the position Pn2 to the position Ps and the length Lp of the base material 9 from the position Ps to the position Pp.

$$\begin{matrix}[ Formula 4 ] & \\ D 2 = Ls 2 + Lp & ( 4 )\end{matrix}$$

As described above, in the printing mode during acceleration as the second mode, the second non-printed amount D2 is calculated on the basis of the transported amount Ls2 of the base material 9 in the printing mode during acceleration by which the base material 9 is transported from the transport start position of the base material 9 to arrive at the printing start position while acceleration of the base material 9 proceeds.

Thus, with the same rear end position Pp of the printed region based on the previous job, the base material saved amount ΔD showing a difference between the first non-printed amount D1 in the standard mode and the second non-printed amount D2 in the printing mode during acceleration is expressed by the following formula.

$$\begin{matrix}[ Formula 5 ] & \\ Δ D = Ls 1 - Ls 2 & ( 5 )\end{matrix}$$

### <2-3. Non-Printed Amount in Reverse Transport Mode (Second Mode)>

Described next is a method of calculating the second non-printed amount D2 corresponding to the length of a non-printed region in the reverse transport mode as one example of the second mode.

In the reverse transport mode, before start of printing based on the new job, the printing controller 61 causes the transport mechanism 20 to perform reverse transport. Then, the printing controller 61 causes the transport mechanism 20 to start transport of the base material 9 in the forward direction and thereafter, causes the printing unit 30 to start printing. The reverse transport means transport of the base material 9 in the reverse direction in comparison to usual transport in the forward direction using the transport mechanism 20. A transport speed of the base material 9 and timing of starting printing after the reverse transport are the same as those in the standard mode.

After the reverse transport, the length of the base material 9 by which the base material 9 is transported in a period from start of transport of the base material 9 to start of printing is the same as the length Ls1 of the base material 9 in the standard mode by which the base material 9 is transported in a period from start of transport of the base material 9 to start of printing. Thus, in determining a reversely transported amount, the printing controller 61 calculates the reversely transported amount using the estimated length Ls1.

In the example in FIG. 6, by giving consideration to the location of the rear end position Bp of the printed region on the base material 9 based on the previous job, the printing controller 61 may set the reversely transported amount to the first non-printed amount D1=Ls1+Lp in the standard mode. By doing so, as a result of the reverse transport of the base material 9, the rear end position Bp of the printed region on the base material 9 based on the previous job becomes located at the position Pn1 along the transport path.

When the transport mechanism 20 starts transport from this state, the position Bp on the base material 9 is located at the printing start position Ps along the transport path at a moment when the base material 9 reaches the stable transport speed Vs and the printing unit 30 starts printing. Then, the printing unit 30 starts the printing process. As a result, with the rear end position Bp of the printed region on the base material 9 based on the previous job set as a printing start position, it becomes possible to perform the printing process based on the new job on the base material 9. Specifically, it is possible to perform the printing process continuously on the base material 9 without providing a non-printed region on the base material 9 between the previous job and the new job. In this case, the second non-printed amount D2 is 0 [m].

In performing the reverse transport, the printing controller 61 stops the meandering compensation by the meandering compensating unit 24, and drives the motors 26 in the reverse direction provided at the unwinding part 21, the winding part 22, and the corresponding transport rollers 23 of the transport mechanism 20.

In the case described above relating to the reverse transport mode, the second non-printed amount D2 is minimized. On the other hand, in the actual printing process, a non-printed region may be provided intentionally. The second non-printed amount D2 is required to be corrected in such a case.

If it is difficult to adjust a transported amount of the base material 9 strictly during the reverse transport, it is probable that printing based on the new job will be started from a position slightly separated toward the downstream side from the rear end position Bp of the printed region based on the previous job. Furthermore, providing a non-printed region on the base material 9 between the printed region based on the previous job and a printed region based on the new job facilitates visual recognition of a boundary between the printed regions based on the corresponding jobs. For these reasons, a non-printed region may be provided intentionally between the rear end position Bp of the printed region based on the previous job and a printing start position of the printed region based on the new job.

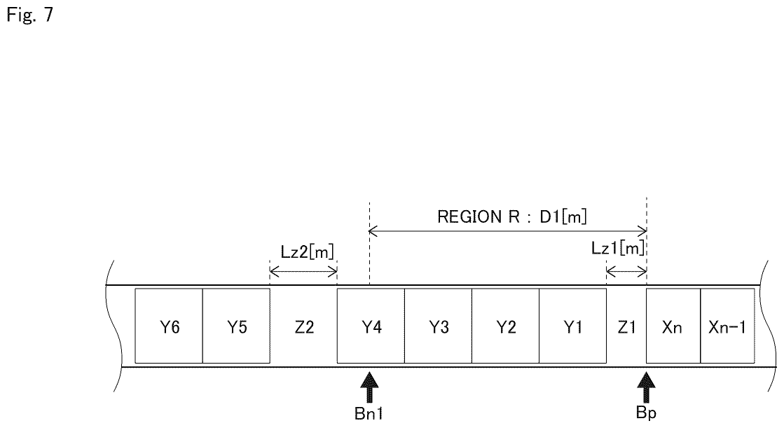

FIG. 7 shows exemplary setting of a non-printed region in the reverse transport mode. FIG. 7 shows exemplary layout on the base material 9 including last two sheets Xn-1 and Xn based on the previous job, and first six sheets Y1, Y2, Y3, Y4, Y5, and Y6 based on the new job.

As shown in FIG. 7, an upstream-side end portion of the last sheet Xn based on the previous job corresponds to the rear end position Bp of the printed region on the base material 9 based on the previous job. A non-printed region Z1 having a set value Lz1 [m] is interposed between the last sheet Xn based on the previous job and the first sheet Y1 based on the new job.

In the example in FIG. 7, a region R having a length D1 on the upstream side with respect to the position Bp is a region having been transported reversely. As described above, the length D1 is obtained as follows: D1=Ls1+Lp [m]. Load may be imposed on the base material 9 having been transported reversely along the transport path formed by the transport mechanism 20 in the housing 200. This might make printing quality in the region R lower than printing quality obtained by the usual printing process. In response to this, as shown in the example in FIG. 7, in order for the sheets Y1, Y2, Y3, and Y4 excluded from quality assurance to become visually recognized clearly, a non-printed region Z2 corresponding to one sheet may be interposed between the sheets Y1, Y2, Y3 and Y4 printed on the region R and the sheets Y5 and Y6 printed on the upstream side with respect to the region R.

In this case, the second non-printed amount D2 in the reverse transport mode is expressed by the following formula using the length Lz1 of the non-printed region Z1 and a length Lz2 of the non-printed region Z2.

$$\begin{matrix}[ Formula 6 ] & \\ D 2 = Lz 1 + Lz 2 & ( 6 )\end{matrix}$$

Thus, the base material saved amount ΔD showing a difference between the first non-printed amount D1 in the standard mode and the second non-printed amount D2 in the reverse transport mode is expressed by the following formula.

$$\begin{matrix}[ Formula 7 ] & \\ Δ D = Ls 1 + Lp - Lz 1 - Lz 2 & ( 7 )\end{matrix}$$

If the reverse transport mode (second mode) is implemented, the non-printed amount can assume any one of three values [1] to [3] described below.
[1] In a case where the upstream-side end portion of the printed region based on the previous job and the downstream-side end portion of the printed region based on the new job are aligned with each other, a non-printed amount is zero (printing based on the new job is started from the position Bp on the base material 9).
[2] In a case where the non-printed region Z1 is interposed between the upstream-side end portion of the printed region based on the previous job and the downstream-side end portion of the printed region based on the new job, the length Lz1 of the non-printed region Z1 corresponds to a non-printed amount (printing based on the new job is started from a position shifted by the length Lz1 toward the upstream side from the position Bp on the base material 9).
[3] In a case where the non-printed region Z1 is interposed between the upstream-side end portion of the printed region based on the previous job and the downstream-side end portion of the printed region based on the new job and the non-printed region Z2 is interposed in the middle of the printed region based on the new job, a non-printed amount is determined by the sum of the length Lz1 of the non-printed region Z1 and the length Lz2 of the non-printed region Z2 (printing based on the new job is started from a position shifted by the length Lz1 toward the upstream side from the position Bp on the base material 9, and printing by the printing unit 30 is interrupted in the non-printed region Z2).

Any of the above three values of the non-printed amount is estimated as a non-printed amount about the new job by the calculation processor 62.

The configuration of transport of the base material 9 by the transport mechanism 20 differs between implementation of the standard mode (first mode) and implementation of the reverse transport mode (second mode). More specifically, the difference lies in whether to transport the base material 9 reversely after finish of the previous job and before start of execution of the new job. The configuration of printing on the base material 9 by the printing unit 30 also differs therebetween. More specifically, the difference lies in whether to start printing based on the new job from the upstream-side end portion of the printed region based on the previous job, whether to start printing based on the new job from a position separated toward the upstream side from the end portion, or whether to interpose a non-printed region in the middle of the printed region based on the new job.

### <3. Display Format on User Computer>

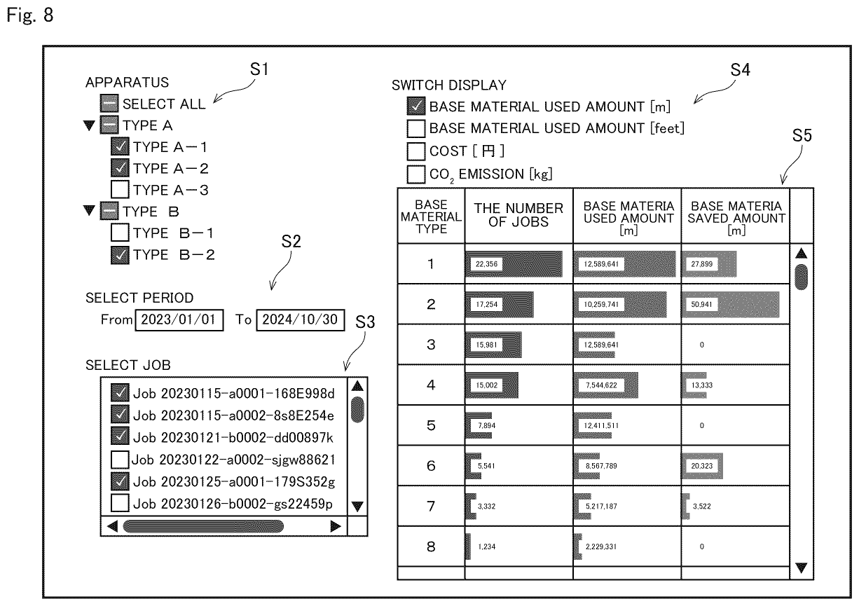

The following describes a display format on the user computer 8 for displaying various types of information about a printed job read from the server computer 7 by referring to FIG. 8. FIG. 8 shows an exemplary display format on the user computer 8 for displaying various types of information about the printed job.

In the example in FIG. 8, a screen appearing on the user display unit 81 of the user computer 8 is composed of an apparatus selection area S1, a period selection area S2, a job selection area S3, a display switching area S4, and an information display area S5. By making selection or input in connection with each item in each of these areas S1 to S5 via the user input unit 82, it becomes possible to check a used amount of the base material 9 or a saved amount of the base material 9 under the selected or input condition.

In the apparatus selection area S1, it is possible to select which printing apparatus 2 among the plurality of printing apparatuses 2 used by a user is to become a subject of display of information. In the period selection area S2, it is possible to select a period desired to be checked. In the job selection area S3, jobs having been executed at the printing apparatuses 2 selected in the apparatus selection area S1 and having been executed in the period selected in the period selection area S2 are displayed, and it is possible to select a job to be checked from the displayed jobs. In the display switching area S4, it is possible to select an item relating to the job selected in the job selection area S3 and desired to be displayed in the information display area S5. In the information display area S5, information about the item selected in the display switching area S4 and relating to the job selected in the job selection area S3 is displayed.

In the example in FIG. 8, “base material used amount [m]” is selected in the display switching area S4. Thus, the following information relating to the job selected in the job selection area S3 is displayed on the basis of each type of the base material 9: the number of jobs having been executed using the base material 9, a total base material used amount [m], and a saved amount [m] of the base material 9 determined by the use of the second mode. Displaying the information in this way allows a user to grasp a used amount of the base material 9 visually. In the example in FIG. 8, it is also possible to check a base material used amount in units of [feet].

In the example in FIG. 8, it is also possible to check a base material cost [yen] instead of a base material used amount. In this case, it is required to input cost per unit length of the base material 9 in advance to the server computer 7 or the user computer 8 on the basis of each type of the base material 9, and form a memory table in advance on the basis of each type of the base material 9 containing association between the unit length of the base material 9 and cost. In displaying the base material cost, a base material used amount and a base material saved amount are applied to the memory table to display the base material used amount and the base material saved amount in terms of cost. By doing so, it further becomes possible to easily check a cost reduction achieved by the use of the second mode.

In the example in FIG. 8, it is also possible to check a CO₂ emission [kg] instead of a base material used amount. In this case, it is required to input a weight per unit length of the base material 9 and an emission intensity (a CO₂ emission per unit length of the base material 9) in advance to the server computer 7 or the user computer 8 on the basis of each type of the base material 9, and form a memory table in advance on the basis of each type of the base material 9 containing association between the unit length of the base material 9 and a CO₂ emission. In displaying a CO₂ emission, a base material used amount and a base material saved amount are applied to the memory table to display the base material used amount and the base material saved amount in terms of a CO₂ emission. By doing so, it further becomes possible to easily check reduction in CO₂ emission achieved by the use of the second mode.

### <4. Modifications>

While one preferred embodiment of the present invention has been described above, the present invention is not to be limited to the above preferred embodiment.

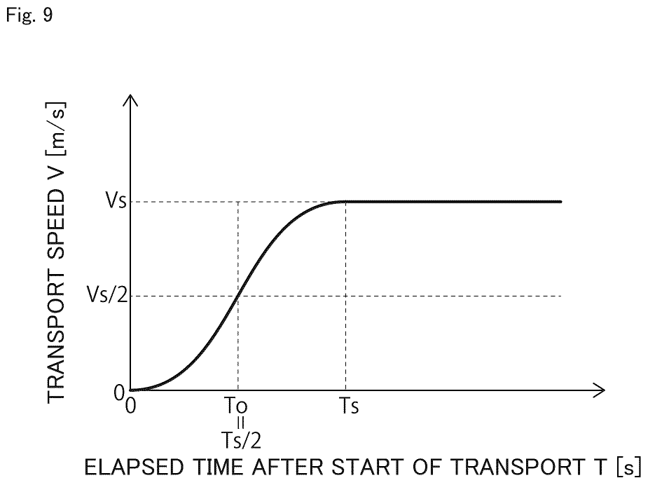

In the printing system of the above preferred embodiment, an acceleration at the start of transport of the base material 9 is constant until a transport speed of the base material 9 reaches the stable transport speed Vs. However, the present invention is not limited to this. An acceleration at the start of transport of the base material 9 may be such that it increases gradually in an initial stage and then decreases gradually in a latter stage to make so-called S-shaped acceleration by which a time series speed changes in an S shape. In this case, a time series change in a transport speed of the base material 9 has a shape such as the one shown in FIG. 9.

FIG. 9 shows a time series changes in the transport speed V [m/s] of the base material 9 under the U-shaped acceleration. Under such S-shaped acceleration, the transport speed V is expressed by the following formula, for example. In the formula (8), a is a constant. The constant a is expressed as a=1, for example.

$$\begin{matrix}[ Formula 8 ] & \\ V = Vs * \frac{1}{1 + {e}^{- a T}} & ( 8 )\end{matrix}$$

Such time series change in the transport speed V [m/s] may be used to calculate the length Ls1 of the base material 9 in the standard mode (first mode) by which the base material 9 is transported in a period from start of transport of the base material 9 to start of printing or the length Ls2 of the base material 9 in the printing mode during acceleration (second mode) by which the base material 9 is transported in a period from start of transport of the base material 9 to start of printing. Specifically, the length Ls1 is determined by integrating the above formula (8) with a time period (T=0 to Ts) from the time (T=0) when transport of the base material 9 is started to the time (T=Ts) when the stable speed Vs is reached. Moreover, a time when printing is started while printing proceeds is defined as a time To. The length Ls2 is determined by integrating the above formula (8) with the time To. A difference between the length Ls1 and the length Ls2 shows a saved distance.

In the printing system of the above preferred embodiment, a processing target is a print sheet configured as the elongated strip-shaped base material. However, in the printing system of the present invention, a processing target may be a sheet-like base material (a resin film, for example) other than generally-used paper.

In the above preferred embodiment, the printing unit 30 is configured to eject ultraviolet-curable ink. However, the printing system of the present invention may be configured to use ink of such a type as will be fixed on the base material 9 by being heated (water-based ink, for example).

In the above preferred embodiment, an inkjet printing apparatus is used as the printing apparatus. However, the printing apparatus according to the present invention may be a plateless printing apparatus of a different type such as electrophotography. In the case of the printing apparatus of the electrophotography system, a print image is recorded by causing toner as a recording agent to adhere to the base material.

An acceleration rate of the base material 9 differs between the standard mode and the printing mode during acceleration described by referring to FIG. 5. However, the base material 9 may be configured to be accelerated at the same acceleration rate in the standard mode and the printing mode during acceleration.

The components described in the above preferred embodiment and in the modifications may be consistently combined together, as appropriate.

While the invention has been shown and described in detail, the foregoing description is in all aspects illustrative and not restrictive. It is therefore understood that numerous modifications and variations can be devised without departing from the scope of the invention.

What is claimed is:

1. A printing apparatus that performs printing on an elongated strip-shaped base material transported in a transport direction, comprising:
a transport mechanism that transports said base material;
a printing unit that records a print image by causing a recording agent to adhere to said base material; and
a control unit that controls each unit in said printing apparatus,
wherein said control unit includes:
a printing controller that controls said transport mechanism and said printing unit, and switches between a first mode and a second mode differing from each other in a configuration of printing on said base material by said printing unit and implements the switched mode; and
a calculation processor that estimates or actually measures a first non-printed amount and a second non-printed amount relating to one job, the first non-printed amount corresponding to the length of a non-printed region of said base material in said first mode, the second non-printed amount corresponding to the length of a non-printed region of said base material in said second mode.

2. The printing apparatus according to claim 1, further comprising:
a display unit allowing information about said printing apparatus to be displayed thereon,
wherein said control unit further includes:
a display controller that displays base material usage information on said display unit having been output from said calculation processor, the base material usage information including at least either said first non-printed amount and said second non-printed amount, or a difference between said first non-printed amount and said second non-printed amount,
wherein said calculation processor estimates said first non-printed amount and said second non-printed amount before start of execution of said job, and
wherein said display controller displays said base material usage information on said display unit.

3. The printing apparatus according to claim 1, further comprising:
a display unit allowing information about said printing apparatus to be displayed thereon,
wherein said control unit further includes:
a display controller that displays base material usage information on said display unit having been output from said calculation processor, the base material usage information including at least either said first non-printed amount and said second non-printed amount, or a difference between said first non-printed amount and said second non-printed amount,
wherein, after execution of said job in said second mode is finished, said calculation processor estimates said first non-printed amount and calculates said second non-printed amount on the basis of result actually measured during implementation of printing, and
wherein said display controller displays said base material usage information on said display unit after execution of said job is finished.

4. The printing apparatus according to claim 1, wherein
in said first mode, when said printing controller starts execution of said job, said printing controller causes said transport mechanism to start transport of said base material and thereafter causes said printing unit to start printing after acceleration is completed and a predetermined stable transport speed is reached,
in said second mode, when said printing controller starts execution of said job, said printing controller causes said transport mechanism to start transport of said base material and thereafter causes said printing unit to start printing while acceleration proceeds and before said stable transport speed is reached,
said first non-printed amount is calculated on the basis of a transported amount of said base material in said first mode by which said base material is transported from a transport start position of said base material to arrive at a printing start position after a transport speed of said base material reaches said stable transport speed, and
said second non-printed amount is calculated on the basis of a transported amount of said base material in said second mode by which said base material is transported from a transport start position of said base material to arrive at a printing start position while acceleration of said base material proceeds.

5. The printing apparatus according to claim 4, wherein
an acceleration of said base material at the start of execution of said job in said second mode is lower than an acceleration of said base material at the start of execution of said job in said first mode.

6. The printing apparatus according to claim 1, wherein
in said first mode, when said printing controller starts execution of said job, said printing controller causes said transport mechanism to start transport of said base material without changing the position of said base material and thereafter causes said printing unit to start printing,
in said second mode, before said printing controller starts execution of said job, said printing controller causes said transport mechanism to perform reverse transport of transporting said base material in a reverse direction, thereafter causes said transport mechanism to start transport of said base material in a forward direction, and then causes said printing unit to start printing,
said first non-printed amount is calculated on the basis of a transported amount of said base material in said first mode by which said base material is transported from a transport start position of said base material to arrive at a printing start position of said base material, and
said second non-printed amount is calculated on the basis of an amount in said second mode obtained by subtracting a transported amount of said base material by which said base material is transported during said reverse transport from a transported amount of said base material by which said base material is transported from a transport start position of said base material to arrive at a printing start position of said base material after said reverse transport.

7. A printing system comprising:
one or a plurality of printing apparatuses that performs printing on an elongated strip-shaped base material transported in a transport direction; and
a server computer including a server display unit and communicable with said printing apparatus via a network,
wherein each of said printing apparatuses includes:
a transport mechanism that transports said base material;
a printing unit that records a print image by causing a recording agent to adhere to said base material; and
a control unit that controls each unit in said printing apparatus,
wherein said control unit includes:
a printing controller that controls said transport mechanism and said printing unit, and switches between a first mode and a second mode differing from each other in a configuration of printing on said base material by said printing unit and implements the switched mode;
a calculation processor that estimates a first non-printed amount and calculates a second non-printed amount relating to a job having been completed in said second mode, the first non-printed amount corresponding to the length of a non-printed region of said base material in said first mode, the second non-printed amount corresponding to the length of a non-printed region of said base material in said second mode and calculated on the basis of result actually measured during implementation of printing; and
a communication part that transmits base material usage information having been output from said calculation processor to said server computer, the base material usage information including at least either said first non-printed amount and said second non-printed amount, or a difference between said first non-printed amount and said second non-printed amount,
wherein said server computer includes:
a server communication part that receives said base material usage information from said printing apparatus via said network; and
a server storage part storing said base material usage information received by said server communication part, and
wherein said server communication part is capable of transmitting said base material usage information stored in the server storage part to an external user computer via said network.
